(19) United States
(12) Patent Application Publication
(10) Pub. No.: US 2005/0111942 A1
(43) Pub. Date: May 26, 2005

(54) Front mounted lifter for front load vehicle and refuse collection method

(76) Inventors: James Rimsa, Countryside, IL (US); Carlos Arrez, Berwyn, IL (US); Ramiro Arrez, Orland Park, IL (US)

Correspondence Address: Stephen B. Heller;Cook, Alex, McFarron, Manzo,, Cummings & Mehler, Ltd., 200 West Adams Street - #2850, Chicago, IL, 60606, US

(21) Appl. No.: 10/718,336

(22) Filed: Nov. 20, 2003

(51) Int. Cl. B65F 3/02

(52) U.S. Cl. 414/408

(57) ABSTRACT

A refuse receptacle lifter is disclosed that is mounted on a transporter secured to the front end of a collection vehicle rearwardly of an associated collection container. The transporter is adapted to move the lifter in a generally side-to-side direction relative to the collection container in order to move the lifter between a retracted position and a position in which it is spaced from the collection container so that it can engage a refuse receptacle. If the collection vehicle does not have a collection container. being carried on the front of the vehicle, the lifter may be moved to stored position generally adjacent to the front end of the vehicle.

The present invention relates generally to a front load refuse collection vehicle and, more particularly, to an apparatus for, and methods of, refuse collection including a receptacle lifter assembly associated with. the front end of the refuse collection vehicle for lifting and dumping the contents of the receptacle into an intermediate refuse collection container located at the front end of the vehicle, which is lifted and dumped into collection vehicle when a sufficient amount of the refuse is collected.

### BACKGROUND OF THE INVENTION

Front load refuse collection vehicles are in wide use in large-scale residential refuse collection. Typically, front load refuse collection vehicle have a front crew cab, a large refuse compartment behind the cab, and a pair of hydraulic-powered lift forks extending in front of. the truck which are adapted to be inserted into corresponding slots or sleeves associated with a relatively large refuse collection container. The forks are then able to lift the refuse container over the front of the truck, invert container, and invert the container in order to dump its contents into the refuse compartment behind the cab.

For residential and small-scale refuse receptacle collection, the front load collection vehicle often carries the collection container in front of the vehicle as it moves along the street. This configuration allows the operator to dump smaller residential receptacles directly into the collection container before the containers dumped into the collection compartment of the vehicle. Typically, this has been a manual operation, with the operator parking the refuse collection vehicle near the receptacle, leaving the cab, and manually lifting and emptying the receptacle into the collection container. As can appreciated, this is unduly time consuming, labor intensive, and can lead to operator injury due to the repeated lifting of the often heavy refuse receptacles.

As a consequence, hydraulic receptacle lifters have been mounted directly to the collection container. Such collection containers with attached hydraulic lifters have been available from Perkins Manufacturing Company, assignee of the present application, since at least 1990. Other examples of collection containers with attached hydraulic lifters are disclosed in U.S. Pat. No. 5,333,984, which is incorporated by reference herein.

More recently, hydraulic lifters have been mounted on collection containers in a manner so that the lift can be mechanically moved into engagement with the refuse receptacle, rather than requiring the operator to move the refuse receptacle to the lifter, thus further reducing the labor required by the operator. Such systems are disclosed in U.S. Pat. Nos. 5,639,201 and 5,607,277, which are also incorporated by reference herein.

While the use of the systems described above has resulted in savings of time and labor, the known systems still have several deficiencies. Because hydraulic connections are typically required between the hydraulic system of the collection vehicle and the carrier-mounted lifter, these connections have been vulnerable to leakage and assorted breakdowns, requiring additional maintenance due, in part to the relatively large range of motion encountered by the container as it has moved over the cab to dump the contents thereof. The repeated lifting places additional stress of the hydraulic system and lines that has also required, in some instances, special designs to prevent the interference between the receptacle lifter and the lift forks for fork lift system of the collection vehicle.

Additionally, some of the container-mounted lifters are compatible only with a specific style of residential refuse receptacle, and are unable to handle containers of different styles. This can result in requiring several collection containers with different lifters for different collection routes, which results in added capital expense for additional equipment.

Accordingly, the primary object of the present invention is to provide an improved refuse collection vehicle and refuse receptacle lifter that results in more efficient methods of refuse collection.

A further object is to provide a refuse collection vehicle having an intermediate collection container with a refuse receptacle lifter that does not require a hydraulic connection between the vehicle and the collection container and the lifter.

Subsidiary objects are to provide a refuse receptacle lifter that can be used for lifting a variety of different style receptacles and to provide a lifter assembly that can be stored in an out-of-the-way position when not in use.

### SUMMARY OF THE INVENTION

These objects, as wells as others that will become apparent upon reference to the following detailed description and accompanying drawings, are provided by an improved refuse collection vehicle, refuse receptacle lifter assembly, and combinations thereof, as well as methods of their use as set forth below. In the context of the present invention, the refuse collection vehicle includes a refuse receiving cavity, a collection container typically mounted to the front of the vehicle, and a lifter assembly. The lifter assembly comprises a refuse receptacle lifter for engaging, lifting, and inverting a refuse receptacle in order to dump its contents into the collection container. The refuse receptacle lifter is mounted on a transporter secured to the vehicle and located rearwardly of the collection container. The transporter is adapted to move the lifter in a generally side-to-side direction relative to the collection container in order to move the lifter between a retracted position and a position in which it is spaced from the collection container so that it can engage a refuse receptacle. The lifter is thus moveable in a generally linear manner from an initial position proximate to the collection container, to a second position for engaging the refuse receptacle spaced laterally from the collection container, and back to the initial position proximate to the collection container for dumping the receptacle. Because the lifter is attached to the vehicle, and not to the collection container, it is not subject to the repeated lifting required for dumping the collection container contents into the vehicle's refuse receiving cavity. Consequently, the hydraulic system is subject to less stress, and no special collection container designs are required.

In accordance with another aspect of the invention, the lifter may be moved to stored position generally adjacent. to the front end of the vehicle when the vehicle is not being used for residential or small receptacle collection. When the vehicle is used on a residential or similar route, the lifter can be easily moved to a working position spaced forwardly of the vehicle and laterally of the collection container.

As set forth in more detail below, the present invention is also embodied by a lifter assembly alone that can be attached to the front end of a front loading refuse collection vehicle. In general, such a lifter assembly may comprise a receptacle lifter for engaging, lifting, and inverting refuse receptacles, and a transporter for mounting in a generally transverse position at the front of the vehicle. The transporter carries the receptacle lifter and is moveable generally side-to-side, so as to move the lifter between a refuse receptacle engaging position and a receptacle dumping position.

The invention is further embodied in a method of refuse collection. First, a refuse collection vehicle, collection container, and lifter assembly, and transporter are provided as described above. Then the combination refuse collection vehicle and the collection container are positioned generally adjacent to a refuse receptacle. Next the refuse receptacle lifter is moved to a pick-up position. Then the refuse receptacle is engaged. Next, the refuse receptacle lifter and the refuse receptacle are moved to a dumping position. Then, the refuse receptacle is lifted and its contents dumped into the collection container. Next, the refuse receptacle lifter is moved to the engaging position to return the refuse receptacle to its original position. Finally, the refuse receptacle is released.

### BRIEF DESCRIPTION OF THE FIGURE OF THE DRAWINGS

FIG. 1 is a perspective view of a front load refuse collection vehicle and refuse receptacle lifter according to the present invention in which the lifter is in its stored position.

FIG. 2 is a perspective view of the refuse collection vehicle as shown in FIG. 2 in combination with a collection container and with the refuse receptacle lifter and its initial working position.

FIG. 3 is a perspective view of the refuse collection vehicle and collection container combination of FIG. 2 with a refuse receptacle lifter extended to its receptacle engaging position.

FIG. 4 is a perspective view of the refuse receptacle lifter according to the present invention with the lifter in its initial working position.

FIG. 5 is a perspective view of the refuse receptacle lifter according the present invention with the lifter in its initial working position from a reverse perspective as compared to FIG. 4.

FIG. 6 is a perspective view of the refuse receptacle lifter according to the present invention with the lifter extended to its receptacle engaging position.

FIG. 7 is a perspective view of the refuse receptacle lifter according to the present invention with the lifter retracted to its initial working position, as shown in FIGS. 2 and 4, but with the lifter inverted to a receptacle dumping position.

FIG. 8 is an enlarged perspective view of an actuator mechanism for use in the present invention that moves grabber arms for engaging a refuse receptacle between open and closed positions.

FIG. 9 is a top view of the actuator mechanism of FIG. 8 showing the grabber arms in the open position.

FIG. 10 is a top view of the actuator mechanism of FIG. 8 showing the grabber arms in the closed position.

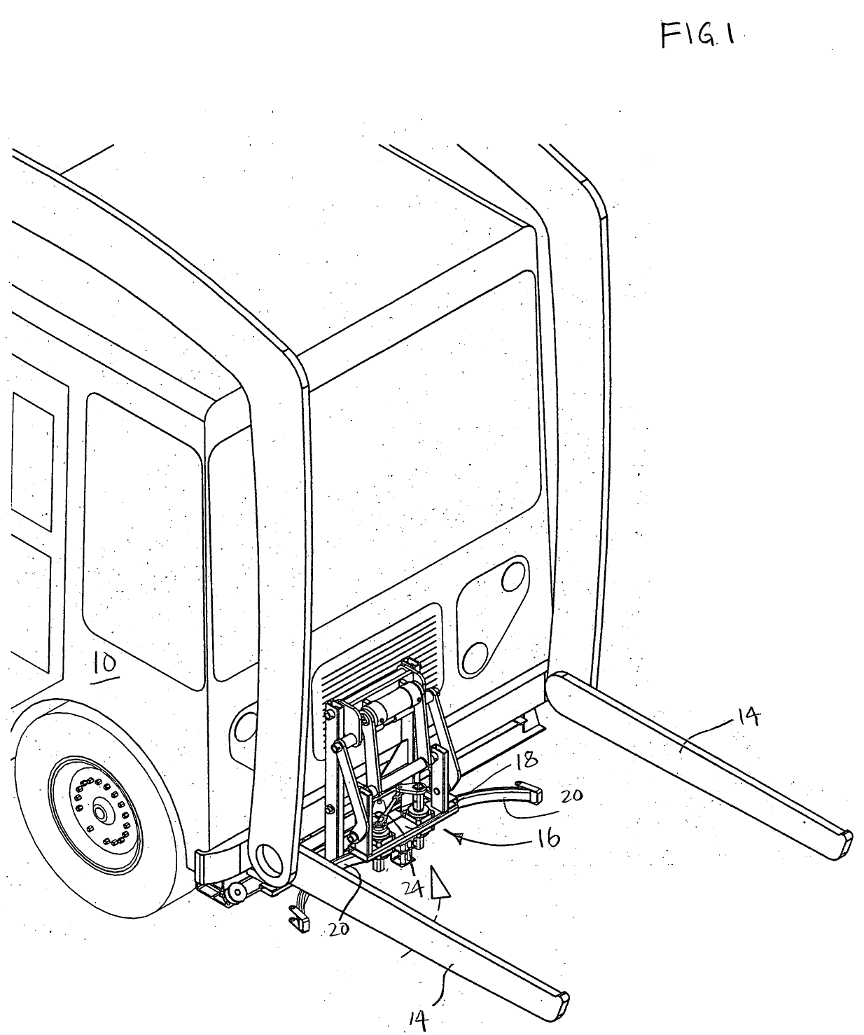

In each of FIGS. 1-10, a refuse receptacle is knot included in order to more clearly show the inventive lifter assembly.

### DETAILED DESCRIPTION

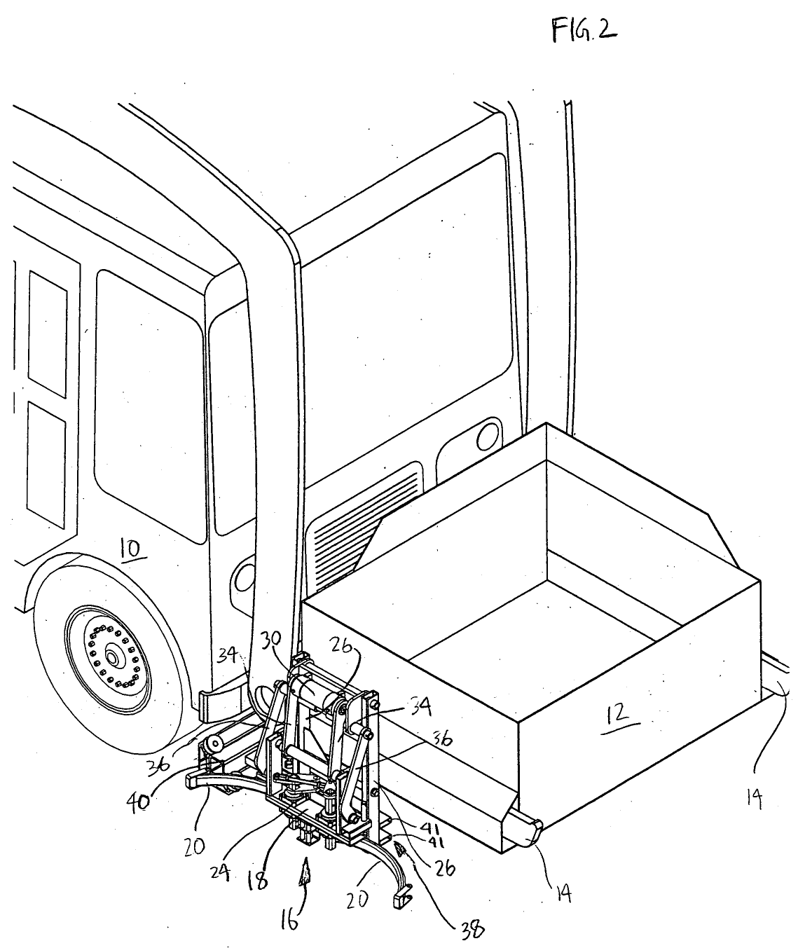

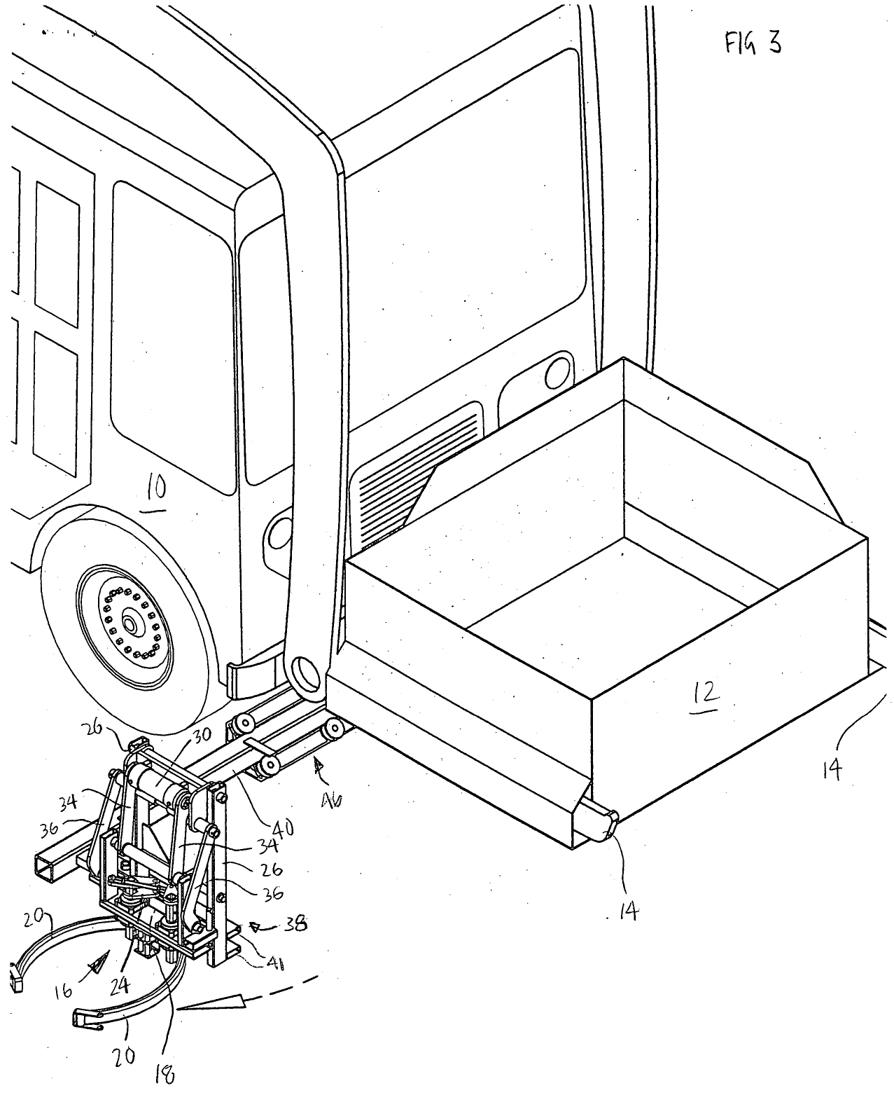

Turning to the figures of the drawings, there is seen in FIGS. 1-3 a front load refuse collection vehicle, generally designated 10, in combination with a collection container or box 12 (seen in FIGS. 2 and 3). The collection container 12 is carried on hydraulically-actuated forks 14 that move the collection container 12 from initial, refuse collection position, as shown in FIG. 2 and 3, to an inverted position over a large refuse compartment (not shown) behind the cab of the vehicle 10 for dumping the contents thereof.

The refuse collection vehicle 10 is provided with a refuse receptacle lifter, generally designated 16, adapted to engage and invert a residential-style refuse receptacle (not shown) in order to dump its contents into the collection container 12.

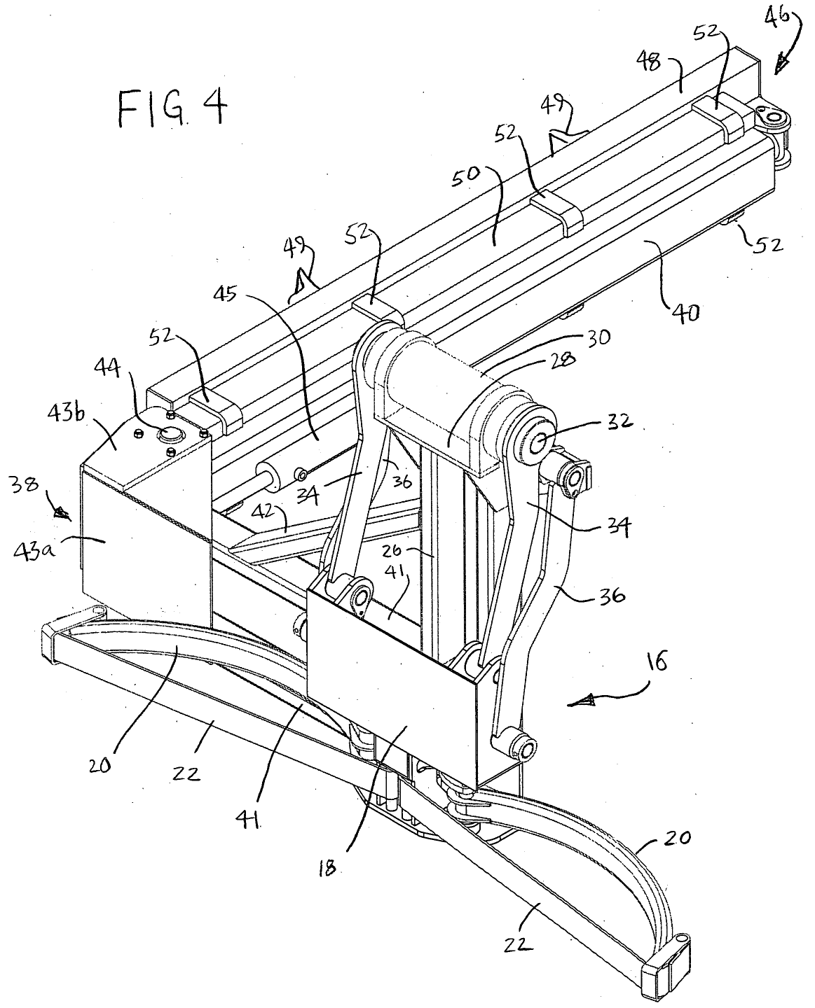

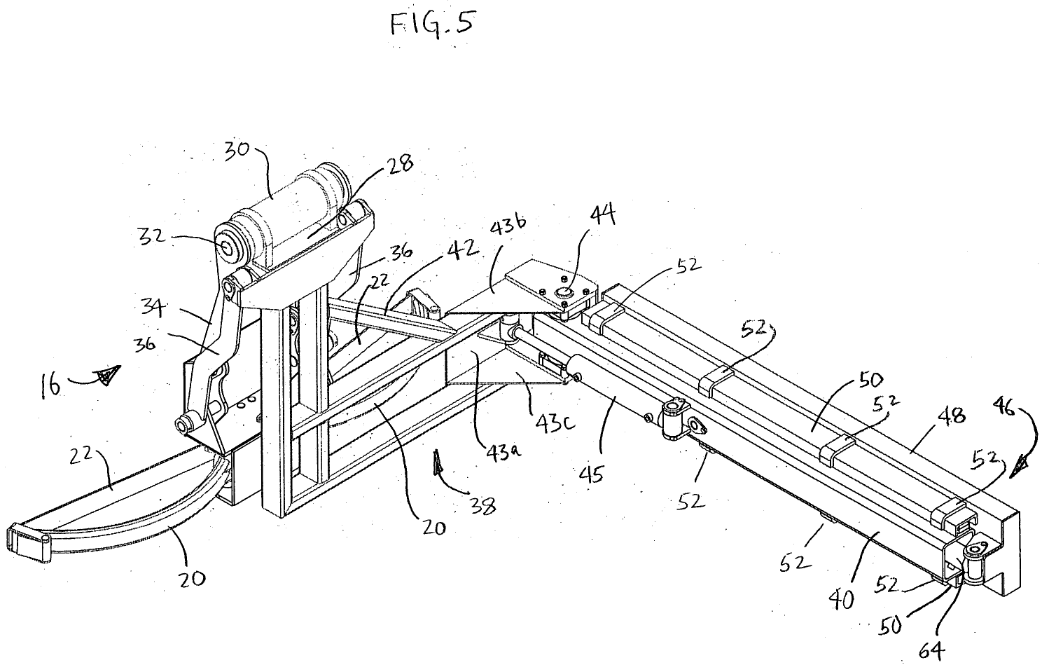

The refuse receptacle lifter 16 is designed is accommodate a variety of residential roll-out refuse containers and includes a carriage 18 having a pair a pivotally-mounted lifter or grabber arms 20. The grabber arms 20 are movable between a first, open position (e.g., FIG. 4), and a second, closed position (FIG. 6) in which the grabber arms 20 are able to securely grip a refuse container for retrieving, lifting and dumping. To this end, the grabber arms 20 include tensioned straps 22 extending between the ends thereof that assist in gripping refuse containers by substantially conforming to the circumferential shape of the refuse container when the grabber arms 20 are in a closed position. An hydraulically-operated actuator mechanism, generally designated 24 moves the grabber arms between the open and closed positions. The actuator 24 will be described in greater detail below.

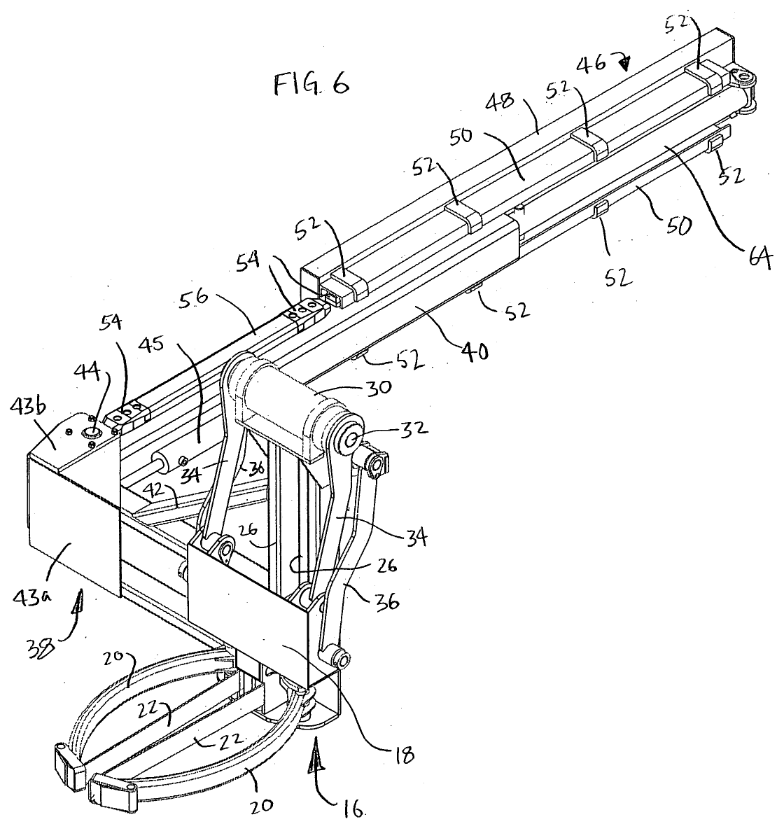

The carriage 18 is mounted with respect to a base structure for movement between a first, lower position (FIG. 4), for engaging refuse receptacles, and a second, inverted position (FIG. 7), for dumping refuse receptacles. The base structure is typically fabricated. from steel tubing and plate and, as illustrated, includes a pair of spaced upright members 26 and a base plate 28. The base plate 28 supports an hydraulic motor or actuator 30 having a generally horizontal rotary actuator shaft 32. On each end of the shaft 32, one end of a lift arm 34 is mounted for rotation therewith, the other end of each lift arm 34 being pivotally mounted to the upper portion of the carriage 18. A pair of follower arms 26 are provided, with one end of each follower arm 36 being pivotally mounted to the lower portion of the carriage 18 and the other end of each follower arm 36 being pivotally mounted to the upper end of the base structure. As is well known, the axes of the lift arms 34 and the follower arms 36 are displaced so as to rotate the carriage 18 as it is inverted to the dumping position.

In keeping with one aspect of the invention, the lifter 16 is mounted to the front end of the collection vehicle 10 (rather than to, e.g., the collection container), so as to be movable between a first, stored position adjacent to the front end of the vehicle 10 (as shown in FIG. 1), to a second, working position forward of the vehicle 10 and adjacent a side of the collection container 12 (as shown in FIG. 2). Thus, when not in use, the lifter 16 may be conveniently retracted to the stored position so as to not interfere with the operation of the refuse collection vehicle 10.

To this end, the receptacle lifter 16 is mounted to a support member, generally indicated by 38, typically fabricated from steel tubing and plate that is pivotally mounted to a beam or extension member 40 in the form of a square tube slidingly secured to the front of the vehicle 10 (as will be discussed in greater detail below).

As best seen in FIG. 5, the support member 38 comprises a pair of spaced-apart, horizontally-oriented steel beams 41, each having a generally rectangular cross-section. The spaced upright members 26 of the receptacle lifter are secured by welding to the outboard ends of the beams 41. Rigidity of the attachment is enhanced by a diagonal brace 42 between the upper beam 41 and the inboard upright member 26. The brace 42 is also preferably made from a steel beam similar in structure to the beams 41. The inboard end of the support member 38 is reinforced with a series of steel plates 43a-c on the face and top and bottom of the support member 38. The top and bottom plates 43b, 43c support the pivot 44 that movably secures the support member 38 to the beam 49.

To move the support member 38 and lifter 16 between the stored position (FIG. 1) and the working position (FIGS. 2, 4 and 5), an hydraulic cylinder 45 is provided that has the cylinder pivotally connected to the beam or slide tube 40 and the rod pivotally connected to the support member 38. As is readily understood, extension and retraction of the rod moves the support member 38 and lifter 16 between the working and stored positions. Of course, other configurations for the structure of the pivoting support member 38 may be used without departing from the scope of the invention, such alternative structures being a function of design choice well within the ordinary skill in the art.

In keeping with another aspect of the invention, the lifter 16 is movable from its working position to a position spaced laterally from the collection container 12 (FIG. 3), to engage and grab a refuse receptacle, and then move back to the working position (FIG. 2) with the refuse receptacle. The lifter 16 can then move to an inverted position (as seen in FIG. 7) to dump the contents of the refuse receptacle into the collection container 12. (The terms “working position” and “receptacle dumping position” may be used interchangeably, and both refer to the position of the lifter 16 as shown in FIGS. 2, 4 and 5).

To this end, the beam 40 is mounted with respect to the front end of the vehicle 10 on a track member, generally designated 46, so as to be movable generally linearly in the direction of the longitudinal axis of the beam 40 between the retracted position, (FIGS. 1, 2, 4, 5 and 7), and the extended position (FIGS. 3 and 6), for engaging and picking up a refuse receptacle.

As best seen in FIG. 6, the track member 46 comprises a base member 48 that is secured to the front of the vehicle 10 by means of a pair of brackets 49. Upper and lower C-channels are secured to the base member 48 by, e.g., welding, with the open faces of the C-channels 50 disposed so that they face towards each other. Brackets 52 may be provided for additional structural support for the C-channels 50 with respect to the base member 48. The slide tube 40 includes a series of eight high-density plastic blocks 54 on its top and bottom that are captured in the openings of the C-channels 50 in order to slidingly support the beam 40 with respect thereto. Preferably, the plastic blocks 54 are made from a composite plastic known as Ultra Comp 300, available from Tri-State Plastics Corp. of Charlotte, N.C. To ensure that the beam or slide tube 40 does not come out of the track member 46 if, for some reason, the blocks 54 fail, additional C-channels 56 are secured to the top and bottom of the slide tube 40 so as to also be captured within the C-channels 50. However, as can be readily appreciated, the C-channels 56 have a profile that is lower than that of the plastic blocks 54 so as to not engage the C-channels 50 under normal operating conditions, but only upon failure of the blocks 54.

To move the beam 40 between the retracted and extended positions, an hydraulic cylinder 64 is provided that has one end secured to the track member 46 and the other end secured to the beam 40. In practice, the cylinder has a throw of approximately 5 feet or 60 inches so as to permit lateral movement of the lifter of 5 feet between its retracted and extended positions. Again, other configurations for the structure of the track member 46 may be used without departing from the scope of the invention, such alternative structures being a matter of design choice well within the ordinary skill of the art.

The operation of the mechanism described above should be self-evident from the drawings. If the collection container 12 is to be carried by the forks 14 of the collection vehicle 10, the lifter 16 is pivoted away from the front of vehicle to the position shown in FIG. 2. In this position, the lifter is adjacent the curb side of the collection container 12. The collection vehicle is driven along its route. As it approaches a residential refuse receptacle, the vehicle 10 is stopped and the transporter beam extended to move the lifter laterally away from the collection container 12 and toward the refuse receptacle. When the lifter is sufficiently close to the refuse receptacle, the grabber arms 20 close so as to firmly grip the refuse receptacle. The transporter beam is then retracted to move the lifter and refuse receptacle to the dumping position (as shown in. FIG. 2). The lifter then inverts the refuse receptacle to dump its contents into the collection container 12. After returning the refuse receptacle to the upright position, the lifter may release the refuse receptacle or the transporter beam may extend so that the refuse receptacle is returned to its original position before being released by the lifter.

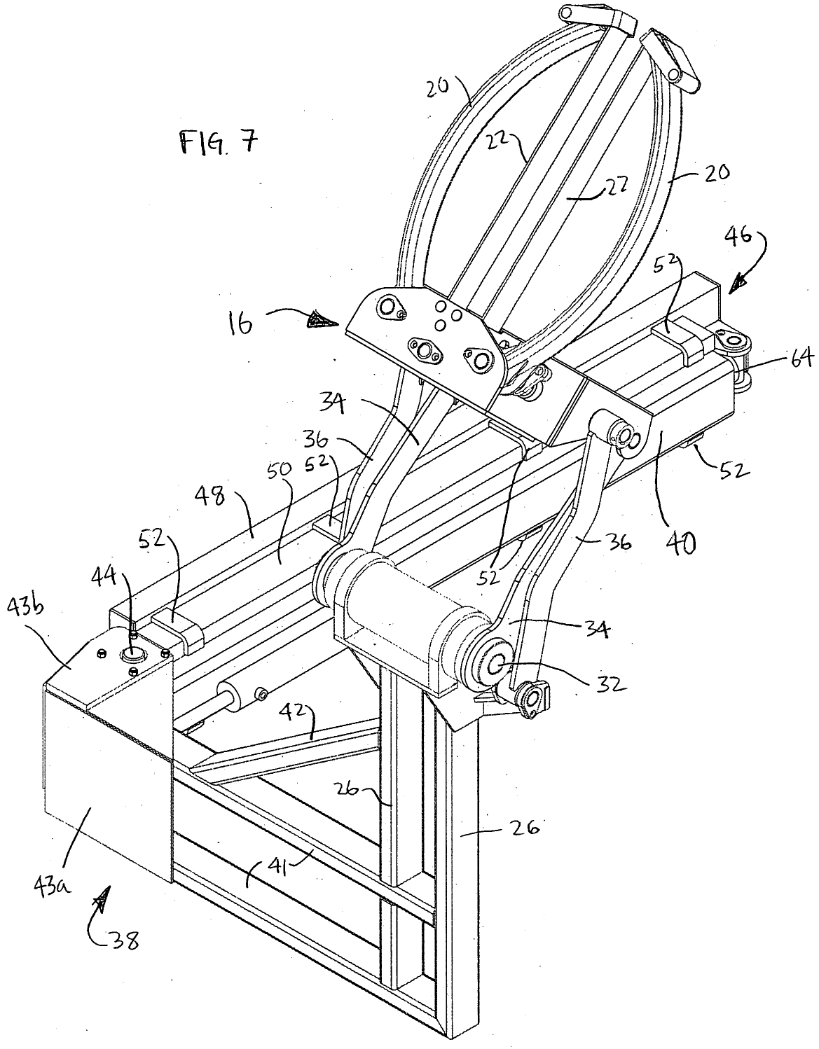

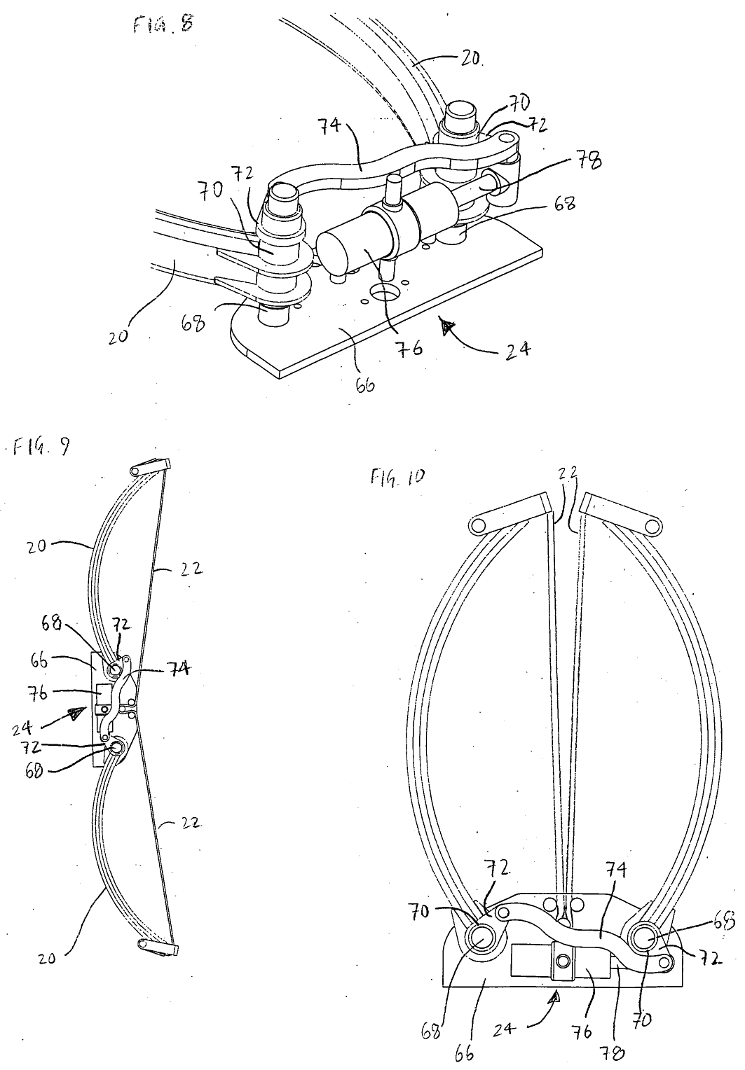

The actuator mechanism 24 for the grabber arms 20 of the lifter may take any of the number of different configurations. A preferred embodiment for the actuator mechanism is shown in FIGS. 8-10. The actuator 24 moves the grabber arms 20 between the open position (FIG. 9) and the closed position (FIG. 10). To this end, each grabber arm 24 is pivotably mounted to a plate 66 that is secured to the lifter support member 38. The pivot comprises a post 68 secured to the plate 66 that receives a sleeve 70 that is integral with the end of each grabber arm 20. Each sleeve 70 has a crank arm 72 affixed thereto, the crank arms 72 being pivotally connected to each other by means of a serpentine link 74. A double-acting hydraulic cylinder 76 is mounted to the plate 66 and has its piston rod 78 pivotably connected to one of the crank arms 72. Thus, by actuation of the hydraulic cylinder 76, the piston rod 78 may be extended to close the grabber arms (FIG. 10) or retracted to open the grabber arms (FIG. 9).

Accordingly, the front mounted lifter and collection method have been disclosed that meets all the objects of the present invention. While the invention has been described in terms of certain preferred embodiments and method, there is no intent to limit the invention to the same. Instead, the invention is defined by the following claims.

1. A refuse receptacle lifter assembly adapted for attachment to front end of front load refuse collection vehicles of the type that are adapted to carry a collection container forward of the vehicle for the accumulation of a quantity of refuse before dumping into a collection cavity in the vehicle, the lifter assembly comprising:
(a) a receptacle lifter for engaging, lifting and inverting refuse receptacles; and
(b) a transporter mounted at the front of the vehicle, the transporter including a track member carrying the receptacle lifter and movable laterally between an extended pickup position in which the track member extends substantially beyond a side of the vehicle to allow the lifter to engage curbside refuse receptacles and a retracted dumping position in which the lifter is located in proximity to the collection container for dumping the refuse receptacle contents thereinto.

2. The refuse receptacle lifter assembly of claim 1, wherein said track member comprises a housing member fixedly mounted to the vehicle, a sliding member to which the receptacle lifter is secured, and an hydraulic cylinder interposed between the housing member and the sliding member for moving the lifter assembly between the pickup and dumping positions.

3. The refuse receptacle lifter assembly of claim 2 wherein the housing member further comprises an elongated tubular member that receives the sliding member therein.

4. The refuse receptacle lifter assembly of claim 1, wherein said transporter comprises a lifter support member pivotally attached to said track member for moving said receptacle lifter between a stored position generally adjacent to the front end of the vehicle and the retracted dumping position spaced forwardly of the vehicle and laterally of the collection container.

5. The refuse receptacle lifter assembly of claim 4, wherein said lifter support member is positioned generally parallel to said track member when said receptacle lifter is in the stored position and generally perpendicular to said track member when said receptacle lifter is in the retracted dumping position.

6. The refuse receptacle lifter assembly of claim 4, wherein said lifter support member further comprises a pair of spaced-apart, horizontally oriented beams having an outboard end to which the receptacle lifter is secured and an inboard end by which the lifter support member is pivotally secured to the track member, and an hydraulic cylinder interposed between the track member and lifter support member for moving the receptacle lifter between the stored and retracted dumping positions.

7. A refuse collection vehicle comprising:
(a) a refuse collection vehicle including a front end, a rear end, two opposed sides, and a refuse receiving cavity;
(b) a lifter assembly carried by said vehicle at the front end thereof comprising:
(i) a refuse receptacle lifter for engaging, lifting, and inverting a refuse receptacle to dump the contents of the refuse receptacle into a collection container; and
(ii) a transporter located at the front end of said vehicle, said transporter carrying said refuse receptacle lifter and movable in a generally side to side direction so as to move said lifter relative to a collection container between a refuse receptacle engaging position spaced laterally from a collection container and a receptacle dumping position generally proximate to a collection container;
whereby said lifter assembly may be used to engage, lift and dump contents of curbside refuse receptacles and the like into a front loaded collection container.

8. The refuse collection vehicle of claim 7, wherein said transporter comprises a track member carrying said refuse receptacle lifter and movable laterally between said receptacle engaging position in which the track member extends substantially beyond a side of the vehicle to said receptacle engaging position to allow said lifter to engage curbside refuse receptacles and said dumping position in which the lifter is located in proximity to a collection container for dumping the refuse receptacle contents thereinto.

9. The refuse collection vehicle of claim 8, wherein said track member comprises a housing member fixedly mounted to the front end of the vehicle, a sliding member to which the receptacle lifter is secured, and an hydraulic cylinder interposed between the housing member and the sliding member for moving the lifter assembly between the pickup and dumping positions.

10. The refuse collection vehicle of claim 9, wherein the housing member further comprises an elongated tubular member that receives the sliding member therein.

11. The refuse collection vehicle of claim 10, wherein said transporter comprises a lifter support member pivotally attached to said track member for moving said receptacle lifter between a stored position generally adjacent to the front end of the vehicle and the receptacle dumping position spaced forwardly of the vehicle and laterally of a collection container.

12. The refuse collection vehicle of claim 11, wherein said lifter support member is positioned generally parallel to said track member when said receptacle lifter is in the stored position and generally perpendicular to said track member when said receptacle lifter is in the receptacle dumping position.

13. A refuse receptacle lifter assembly adapted for attachment to front end of front load refuse collection vehicles of the type that are adapted to carry a collection container forward of the vehicle for the accumulation of a quantity of refuse before dumping into a collection cavity in the vehicle, the lifter assembly comprising:
(a) a receptacle lifter for engaging, lifting and inverting refuse receptacles;
(b) a transporter mounted at the front of the vehicle carrying the receptacle lifter, said transporter comprising a lifter support member pivotally attached to the front end of the vehicle for moving said receptacle lifter between a stored position generally adjacent to the front end of the vehicle and the retracted dumping position spaced forwardly of the vehicle and laterally of the collection container.

14. The refuse receptacle lifter assembly of claim 13, wherein said lifter support member is positioned generally parallel to the front end of the vehicle when said receptacle lifter is in the stored position and generally perpendicular to the front end of the vehicle when said receptacle lifter is in the retracted dumping position.

15. The refuse receptacle lifter assembly of claim 13, wherein said lifter support member further comprises a pair of spaced-apart, horizontally oriented beams having an outboard end to which the receptacle lifter is secured and an inboard end by which the lifter support member is pivotally secured. to the. track member, and an hydraulic cylinder interposed between the track member and lifter support member for moving the receptacle lifter between the stored and retracted dumping positions.

16. A refuse collection vehicle comprising:
(a) a refuse collection vehicle including a front end, a rear end, two opposed sides, and a refuse receiving cavity;
(b) a lifter assembly carried by said vehicle at the front end thereof comprising:
(i) a refuse receptacle lifter for engaging, lifting, and inverting a refuse receptacle to dump the contents of the refuse receptacle into a collection container; and
(ii) a transporter located at the front end of said vehicle, said transporter comprising a lifter support member pivotally attached to the front end of the vehicle for moving said receptacle lifter between a stored position generally adjacent to the front end of the vehicle and the receptacle dumping position spaced forwardly of the vehicle and laterally of a collection container.

17. The refuse collection vehicle of claim 16, wherein said lifter support member is positioned generally parallel to the front end of the vehicle when said receptacle lifter is in the stored position and generally perpendicular to the front end of the vehicle when said receptacle lifter is in the receptacle dumping position.

18. The refuse receptacle lifter assembly of claim 4, wherein said lifter support member further comprises a pair of spaced-apart, horizontally oriented beams having an outboard end to which the receptacle lifter is secured and an inboard end by which the lifter support member is pivotally secured to the track member, and an hydraulic cylinder interposed between the track member and lifter support member for moving the receptacle lifter between the stored and retracted dumping positions.

19. A refuse receptacle lifter assembly adapted form attachment to front end of front load refuse collection vehicles of the type that are adapted to carry a collection container forward of the vehicle for the accumulation of a quantity of refuse before dumping into a collection cavity in the vehicle, the lifter assembly comprising:
(a) a receptacle lifter for engaging, lifting and inverting refuse receptacles;
(b) a transporter mounted in a generally transverse position at the front of the vehicle, the transporter including a track member carrying the receptacle lifter and movable laterally between an extended pickup position in which the track member extends substantially beyond a side of the vehicle to allow the lifter to engage curbside refuse receptacles and a retracted dumping position in which the lifter is located in proximity to the collection container for dumping the refuse receptacle contents thereinto; said transporter further comprising a lifter support member pivotally attached to said track member for moving said receptacle lifter between a stored position generally adjacent to the front end of the vehicle and the retracted dumping position spaced forwardly of the vehicle and laterally of the collection container.

20. The refuse receptacle lifter assembly of claim 19, wherein said track member comprises a housing member fixedly mounted to the vehicle, a sliding member to which the receptacle lifter is secured, and an hydraulic cylinder interposed between the housing member and the sliding member for moving the lifter assembly between the pickup and dumping positions.

21. The refuse receptacle lifter assembly of claim 20 wherein the housing member further comprises an elongated tubular member that receives the sliding member therein.

22. The refuse receptacle lifter assembly of claim 19, wherein said lifter support member is positioned generally parallel to said track member when said receptacle lifter is in the stored position and generally perpendicular to said track member when said receptacle lifter is in the retracted dumping position.

23. The refuse receptacle lifter assembly of claim 19, wherein said lifter support member further comprises a pair of spaced-apart, horizontally oriented beams having an outboard end to which the receptacle lifter is secured and an inboard end by which the lifter support member is pivotally secured to the track member, and an hydraulic cylinder interposed between the track member and lifter support member for moving the receptacle lifter between the stored and retracted dumping positions.

24. A refuse collection vehicle comprising:
(a) a refuse collection vehicle including a front end, a rear end, two opposed sides, and a refuse receiving cavity;
(b) a lifter assembly carried by said vehicle at the front end thereof comprising:
(i) a refuse receptacle lifter for engaging, lifting, and inverting a refuse receptacle to dump the contents of the refuse receptacle into a collection container; and
(ii) a transporter located at the front end of said vehicle, said transporter carrying said refuse receptacle lifter and movable in a generally side to side direction so as to move said lifter relative to a collection container between a refuse receptacle engaging position spaced laterally from a collection container and a receptacle dumping position generally proximate to a collection container; said transporter further comprising a lifter support member for moving said receptacle lifter between a stored position generally adjacent to the front end of the vehicle and the receptacle dumping position spaced forwardly of the vehicle and laterally of a collection container; whereby said lifter assembly may be used to engage, lift and dump contents of curbside refuse receptacles and the like into a front loaded collection container.

25. The refuse collection vehicle of claim 24, wherein said transporter comprises a track member carrying said refuse receptacle lifter and movable laterally between said receptacle engaging position in which the track member extends substantially beyond one side of the vehicle to said receptacle engaging position to allow said lifter to engage curbside refuse receptacles and said dumping position in which the lifter is located in proximity to a collection container for dumping the refuse receptacle contents thereinto.

26. The refuse collection vehicle of claim 25, wherein said track member comprises a housing member fixedly mounted to the front end of the vehicle, a sliding member to which the receptacle lifter is secured, and an hydraulic cylinder interposed between the housing member and the sliding member for moving the lifter assembly between the receptacle engaging and dumping positions.

27. The refuse collection vehicle of claim 26 wherein the housing member further comprises an elongated tubular member that receives the sliding member therein.

28. The refuse collection vehicle of claim 45, wherein said lifter support member is positioned generally parallel to said track member when said receptacle lifter is in the stored position and generally perpendicular to said track member when said receptacle lifter is in the receptacle dumping position.

29. The refuse receptacle lifter assembly of claim 28, wherein said lifter support member further comprises a pair of spaced-apart, horizontally oriented beams having an outboard end to which the receptacle lifter is secured and an inboard end by which the lifter support member is pivotally secured to the track member, and an hydraulic cylinder interposed between the track member and lifter support member for moving the receptacle lifter between the stored and retracted dumping positions.

30. A method refuse collection comprising the steps:
(A) providing a combination refuse collection vehicle and collection container comprising:
(i) a refuse collection vehicle including a front end, a read end and opposed sides, and further including a refuse receiving cavity;
(ii) a collection container carried at the front of the vehicle;
(iii) a lifter assembly carried by the vehicle at the front thereof comprising:
(a) a refuse receptacle lifter for engaging, lifting, and inverting a refuse receptacle to dump contents of the refuse receptacle into said collection container; and
(b) a transporter carried at the front of said vehicle aft of said collection container, the transporter carrying said refuse receptacle lifter for movement in a generally side to side direction relative to the collection container, between a refuse receptacle engaging position spaced from collection container and a receptacle dumping position generally proximate to the collection container;
(B) positioning the combination refuse collection vehicle and container generally adjacent to a refuse receptacle;
(C) moving said refuse receptacle lifter to the refuse receptacle engaging position;
(D) engaging said refuse receptacle;
(E) moving said refuse receptacle lifter and refuse receptacle to the dumping position;
(F) lifting and dumping the contents of said refuse receptacle into said front loaded collection container;
(G) moving said refuse receptacle lifter to the engaging position; and
(H) releasing the refuse receptacle.
